(19) United States
(12) Patent Application Publication
(10) Pub. No.: US 2022/0253320 A1
(43) Pub. Date: Aug. 11, 2022

(54) METHOD AND SYSTEM FOR OPERATING A WEB APPLICATION ON A DEVICE

(71) Applicant: YANDEX EUROPE AG, Luzern (CH)

(72) Inventors: Eduard Ilfatovich SATDAROV, Moscow (RU); Pavel Nikolaevich VOROBKALOV, Volgograd (RU); Konstantin Borisovich GANENKO, Novosibirsk (RU); Dmitry Sergeevich GOLUBNICHY, Moscow (RU); Leonid Vladimirovich KAPLAN, Sankt-Peterburg (RU); Dmitry Aleksandrovich ILINSKY, Moscow (RU); Vitaly Viktorovich KALCHENKO, Novosibirsk (RU); Ilya Vladimirovich BOGIN, Moscow (RU)

(21) Appl. No.: 17/480,224

(22) Filed: Sep. 21, 2021

(30) Foreign Application Priority Data
Feb. 10, 2021 (RU) 2021103264

(51) Int. Cl. G06F 9/445; G06F 12/0802; G06F 16/9038

(52) U.S. Cl. CPC G06F 9/445; G06F 2212/60; G06F 16/9038; G06F 12/0802

(57) ABSTRACT

A method and system for operating a web application on a device. The method comprises, in response to a triggering event, launching the web application for interaction with a selected web resource. The method accesses a local cache comprising static data, the static data defining shared portions of records, each of the shared portions of records being associated with at least two of the web resources, each of the shared portions of records defining static content common to the corresponding at least two of the web resources. The method also selects at least one shared portion of records associated with the selected resource and retrieves the at least one shared portion of records associated with the selected resource and also retrieves the dynamic component for the selected resource. The method also comprises processing the static component and the dynamic component to generate content to be displayed by the device.

### CROSS-REFERENCE

The present application claims priority to Russian Patent Application No. 2021103264, entitled “METHOD AND SYSTEM FOR OPERATING A WEB APPLICATION ON A DEVICE,” filed on Feb. 10, 2021, the entirety of which is incorporated herein by reference.

### FIELD

The present technology generally relates to systems and methods for operating a web application on a device, and, in particular, to methods and systems for fast opening of webpages in a progressive web applications (PWAs).

### BACKGROUND

Web applications may be considered as a specific variant of client-server software where the client software is downloaded to the client machine when visiting the relevant web page, using standard procedures or protocols such as HTTP. Client web software updates may happen each time the web page is visited. During the session, the web browser interprets and displays the pages, and acts as the universal client for any web applications. Web applications rely on web documents written in a standard format such as, for example, HTML and JavaScript, and are typically supported by variety of web browsers. In contrast, native applications are usually tightly bound to a particular computer architecture and/or to a particular operating system. As an example, a native application designed to operate on iOS™from Apple Inc. will not, de facto, be executable on a device operating Android™from Google Inc.

While web applications inherently alleviate constraints of portability and executability by different types of computer architectures and/or operating systems, they still present limitations. Examples of such limitations include slow speed of execution and fewer features compared to native applications. As a result, web applications have been less used than native applications. In an attempt to close the gap between web applications and native applications, a new technology has recently emerged, progressive web applications (PWAs). A progressive web application (PWA) is a type of application software delivered through the web, built using common web technologies, including, for example, but without being limited thereto, HTML, CSS and JavaScript. PWAs are intended to work on any platform that uses a standards-compliant browser, including both desktop and mobiles devices. PWAs are gaining an increased popularity thanks to features such as their ability to work offline, their level of performance (compared to web applications), their ability to access mobile device's sensors, their support for push notifications, to name a few. In some implementations, fast opening of webpages by PWAs is implemented through the use of service worker which acts as a proxy layer in the PWA. This proxy layer allows controlling how network requests are handled and connecting a back end of the PWA (i.e., a remote server) with a front end (i.e., the PWA running on the device). While providing benefits, relying on the service worker approach may prove to be cumbersome. Alternative approaches are therefore desirable.

In addition to the service worker described herein above in the context of PWA, other known approaches include approaches described in on of the following: Chinese patent application published under reference CN106202179A and entitled “Page Loading Method and Device”, U.S. patent application published under reference US2018/285470A1 and entitled “A Mobile Web Cache Optimization Method Based on HTML5 Application Caching” and European patent application published under reference EP1081607A2 and entitled “Method for Providing Fast Access to Dynamic Content on the World Wide Web”.

Chinese patent application published under reference CN106202179A discloses a page loading method and device. The method comprises determining whether a browser has locally stored the content of an assigned portion of an assigned page when the browser needs to load the assigned page; if yes, determining whether to request the content from a server of the assigned page; if the request from the server is not needed, taking the browser locally stored content as the content of the assigned portion of the assigned page, and loading same.

U.S. patent application published under reference US2018/285470A1 discloses a mobile web cache optimization method including the steps of: 1) crawling the resource information in the mobile web application by a server; 2) mapping resources having the same content but different URLs to a same resource; 3) selecting a stable set of resources to configure in the cache resource list; 4) setting a JavaScript runtime library, invoking a call to the runtime in each target page; 5) generating a proxy page for each target page, redirecting URL of a target page to the corresponding proxy page, and when a target page is accessed, querying the resource mapping file according to the requested resource, and retrieving the matching cache resource from the cache resource list to load onto the proxy page.

European patent application published under reference EP1081607A2 discloses a smart bookmark stored sequence of browsing steps performed by a user that have been recorded in a transparent manner and which can be automatically played and replayed later when the smart bookmark is accessed. When a user elects to create a smart bookmark, a Java recorder-player applet is invoked that starts the recording process. When the recording process is started and an initial URL is inputted by the user, the responsive Web page at that URL downloaded into the browser is modified to attach event handlers to each element in that page that is associated with actions that the user may take.

### SUMMARY

Non-limiting embodiments of the present technology have been developed based on developer's appreciation of at least one technical problem associated with the prior art solutions.

In accordance with a first broad aspect of the present technology, there is provided a method of operating a web application on a device, the method comprising:

in response to a triggering event, launching the web application for interaction with a selected web resource, the triggering event being determined based on a scope associated with the web application, the scope comprising resource identifiers identifying web resources;

accessing, by the web application, a local cache stored in a computer-readable memory of the device, the local cache comprising static data, the static data defining shared portions of records, each of the shared portions of records being associated with at least two of the web resources, each of the shared portions of records defining static content common to the corresponding at least two of the web resources;

selecting, by the web application, amongst the shared portions of records stored in the local cache, at least one shared portion of records associated with the selected resource;

retrieving, by the web application, the at least one shared portion of records associated with the selected resource, the retrieved shared portions defining a static component for the selected resource;

retrieving, by the web application, from the selected web resource, a dynamic component for the selected resource; and

processing, by the web application, the static component and the dynamic component to generate content to be displayed by the device.

In some non-limiting embodiments of the present technology, the resource identifiers are Uniform Resource Locators (URLs) associated with the web resources.

In some non-limiting embodiments of the present technology, the triggering event is determined by a comparison of a first URL associated with the selected web resource with URLs of the scope associated with the web application.

In some non-limiting embodiments of the present technology, the triggering event is an action of navigating from a SEarch Results Page (SERP) to the selected resource.

In some non-limiting embodiments of the present technology, the association of the shared portions of records with the at least two of the web resources is determined based on an association of a first one of the resource identifiers associated with a first one of the at least two web resources and a second one of the resource identifiers associated with a second one of the at least two web resources.

In some non-limiting embodiments of the present technology, the association is based on the first one of the resource identifiers and the second one of the resource identifiers having a common prefix.

In some non-limiting embodiments of the present technology, the association is predefined based on TF/IDF parameters.

In some non-limiting embodiments of the present technology, the association is predefined based on predefined n-grams.

In some non-limiting embodiments of the present technology, launching the web application for interaction comprises opening a web page comprising the static component and the dynamic component.

In some non-limiting embodiments of the present technology, the static data stored in the local cache further defines static content unique to the selected resource.

In some non-limiting embodiments of the present technology, retrieving, by the web application, from the selected web resource, the dynamic component comprises executing a Java script routine downloading the dynamic component from a server associated with the selected web resource.

In some non-limiting embodiments of the present technology, the static content comprises at least one of a profile page of a social media, a new page or a template page.

In some non-limiting embodiments of the present technology, the at least one shared portion of records associated with the selected resource comprises a first shared portion of records associated with the selected resource and a second shared portion of records associated with the selected resource.

In accordance with a second broad aspect of the present technology, there is provided a system for operating a web application, the system comprising a computer- readable memory storing instructions which, upon being executed by a processor of the system, causes:

in response to a triggering event, launching the web application for interaction with a selected web resource, the triggering event being determined based on a scope associated with the web application, the scope comprising resource identifiers identifying web resources;

accessing, by the web application, a local cache stored in a computer-readable memory of the device, the local cache comprising static data, the static data defining shared portions of records, each of the shared portions of records being associated with at least two of the web resources, each of the shared portions of records defining static content common to the corresponding at least two of the web resources;

selecting, by the web application, amongst the shared portions of records stored in the local cache, at least one shared portion of records associated with the selected resource;

retrieving, by the web application, the at least one shared portion of records associated with the selected resource, the retrieved shared portions defining a static component for the selected resource;

retrieving, by the web application, from the selected web resource, a dynamic component for the selected resource; and

processing, by the web application, the static component and the dynamic component to generate content to be displayed by the device.

In the context of the present specification, a “server” is a computer program that is running on appropriate hardware and is capable of receiving requests (e.g. from electronic devices) over the network, and carrying out those requests, or causing those requests to be carried out. The hardware may be one physical computer or one physical computer system, but neither is required to be the case with respect to the present technology. In the present context, the use of the expression a “at least one server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended to imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, unless provided expressly otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

### DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of a system implemented in accordance with non-limiting embodiments of the present technology;

FIG. 2 depicts a schematic diagram of an electronic device implemented in accordance with non-limiting embodiments of the present technology;

FIGS. 3 and 4 depict schematic illustrations of database stored in a local cache; and

FIG. 5 depicts a block diagram of a flow chart of a method for operating a web application in accordance with non-limiting embodiments of the present technology.

### DETAILED DESCRIPTION

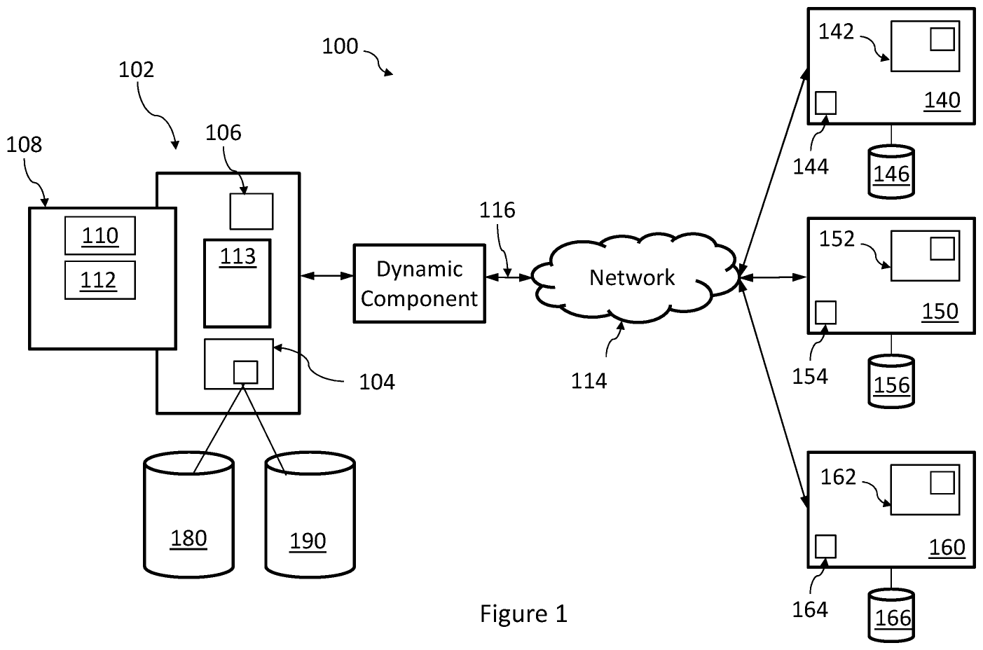

Referring to FIG. 1, there is shown a schematic diagram of a system 100, the system 100 being suitable for implementing non-limiting embodiments of the present technology. It is to be expressly understood that the system 100 is depicted merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope. Furthermore, as an aid to understanding, the following description may describe relatively simplified implementations of the present technology. As persons skilled in the art would understand, various implementations of the present technology may be of greater complexity.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

With these fundamentals in place, we will now consider some non-limiting examples to illustrate various implementations of aspects of the present technology.

The system 100 comprises an electronic device 102. The electronic device 102 is typically associated with a user (not depicted) and, as such, can sometimes be referred to as a “client device”. It should be noted that the fact that the electronic device 102 is associated with the user does not mean to suggest or imply any mode of operation- such as a need to log in, a need to be registered or the like.

In the context of the present specification, unless provided expressly otherwise, “electronic device” is any computer hardware that is capable of running a software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as an electronic device in the present context is not precluded from acting as a server to other electronic devices. The use of the expression “an electronic device” does not preclude multiple client devices being used in receiving/sending, carrying out or causing to be carried out any task or request, or the consequences of any task or request, or steps of any method described herein.

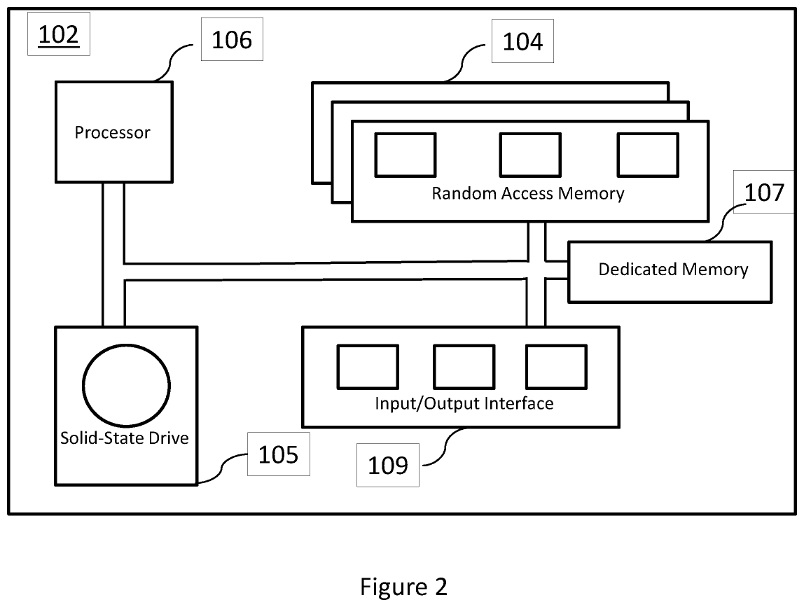

Referring concurrently to FIGS. 1 and 2, the electronic device 102 may comprise one or more storage media 104, 105, 107 and generally provides a place to store computer-executable program instructions executable by one or processors 106. By way of example, the one or more storage media may be implemented as tangible computer- readable storage medium including Random-Access Memory (RAM). The one or more storage media 104, 105, 107 may also include one or more fixed storage devices in the form of a permanent storage 105. The permanent storage 105 may encompass one or more storage media and generally provides a place to store computer-executable instructions executable by a processor 106. By way of example, the permanent storage 105 may be implemented as a computer-readable storage medium including Read-Only Memory (ROM), hard disk drives (HDDs), solid-state drives (SSDs), and flash-memory cards.

The electronic device 102 comprises hardware and/or software and/or firmware (or a combination thereof), as is known in the art to execute a browser application 108. Generally speaking, the purpose of the browser application 108 is to enable the user (not depicted) to access one or more web resources. The manner in which the browser application 108 is implemented is known in the art and will not be described herein. Suffice it to say that the browser application 108 may be one of Google™Chrome™browser, Yandex.Browser™browser, or other commercial or proprietary browsers.

Irrespective of how the browser application 108 is implemented, the browser application 108, typically, has a command interface 110 and a browsing interface 112. Generally speaking, the user (not depicted) can access a web resource via a communication network by two principle means. The given user can access a particular web resource directly, either by typing an address of the web resource (typically an URL or Universal Resource Locator, such as www.example.com) into the command interface 110 or by clicking a link in an e-mail or in another web resource (which action will in a sense “copy and paste” the URL associated with the link into the command interface 110).

Alternatively, the given user may conduct a search using a search engine service (not depicted) to locate a resource of interest based on the user's search intent. The latter is particularly suitable in those circumstances, where the given user knows a topic of interest, but does not know the URL of the web resource she is interested in. The search engine typically returns a Search Engine Result Page (SERP) containing links to one or more web resources that are responsive to the user query. Again, upon the user clicking one or more links provided within the SERP, the user can open the required web resource.

Also shown on FIG. 1 is a web application 113. As it will be further discussed herein below, the web application 113 may be operated partially or fully by the browser application 108. In some embodiments, the web application 113 is a progressive web application (PWA) which may be defined as a subset of web applications intended to work on any platform that uses a standards-compliant browser application, including desktop and mobile devices. In some embodiments, the PWA operates common web technologies, such as, but without being limited thereto, HTML, CSS and/or JavaScript.

The electronic device 102 comprises a communication interface (not depicted) for two-way communication with a communication network 114 via a communication link 116. In some embodiments, the communication interface is part of a set of input/output interfaces 109. In some non-limiting embodiments of the present technology, the communication network 114 can be implemented as the Internet. In other embodiments of the present technology, the communication network 114 can be implemented differently, such as any wide-area communication network, local area communications network, a private communications network and the like.

How the communication link 116 is implemented is not particularly limited and depends on how the electronic device 102 is implemented. Merely as an example and not as a limitation, in those embodiments of the present technology where the electronic device 102 is implemented as a wireless communication device (such as a smart phone), the communication link 116 can be implemented as a wireless communication link (such as, but not limited to, a 3G communications network link, a 4G communications network link, a Wireless Fidelity, or WiFi®, for short, Bluetooth®, or the like) or wired (such as an Ethernet based connection).

It should be expressly understood that implementations for the electronic device 102, the communication link 116 and the communication network 114 are provided for illustration purposes only. As such, those skilled in the art will easily appreciate other specific implementational details for the electronic device 102, the communication link 116 and the communication network 114. As such, by no means the examples provided hereinabove are meant to limit the scope of the present technology.

The system 100 further includes servers 140, 150 and 160 coupled to the communication network 114. The servers 140-160 can be implemented as conventional computer servers. In an example of an embodiment of the present technology, the servers 140-160 can be implemented as a Dell™PowerEdge™Server running the Microsoft™Windows Server™operating system. Needless to say, the servers 140-160 can be implemented in any other suitable hardware and/or software and/or firmware or a combination thereof In the depicted non-limiting embodiment of the present technology, each of the servers 140-160 is single server. In alternative non-limiting embodiments of the present technology, the functionality of each of the servers 140-160 may be distributed and may be implemented across multiple servers.

The implementation of the servers 140-160 is well known. However, briefly speaking, the servers 140-160 comprise a communication interface (not depicted) structured and configured to communicate with various entities (such as the electronic device 102 and other devices potentially coupled to the communication network 114). Similar to the electronic device 102, each of the servers 140-160 comprises server memories 142, 152 and 162 which comprises one or more storage media and generally provides a place to store computer-executable program instructions executable by server processors 144, 154 and 164. By way of example, the server memories 142, 152 and 162 may be implemented as tangible computer-readable storage medium including Read-Only Memory (ROM) and/or Random-Access Memory (RAM). The server memories 142, 152 and 162 may also include one or more fixed storage devices in the form of, by way of example, hard disk drives (HDDs), solid-state drives (SSDs), and flash-memory cards.

In some embodiments, each of the servers 140-160 can be operated by the same entity that has provided the afore-described browser application 108. For example, if the browser application 108 is a Yandex.Browser™browser, at least one of the servers 140-160 can be operated by Yandex LLC of Lev Tolstoy Street, No. 16, Moscow, 119021, Russia. In alternative embodiments, one of the servers 140-160 can be operated by an entity different from the one who has provided the afore-mentioned browser application 108.

In some embodiments of the present technology, and generally speaking, each of the servers 140-160 functions as a repository for dedicated web resources 144, 154, 164. In other embodiments, each of the servers 140-160 may be associated with multiple web resources (e.g., the server 140 may host web resources 144 and 154). In yet other embodiments, a given web resource may be associated with a plurality of servers 140-160 (e.g., the web resource 144 may be hosted on servers 140 and 150). In the context of the present specification, the term “web resource” refers to any network resource (such as a web page, web site or a web service), which content is visually presentable by the electronic device 102 to the user, via the browser application 108, and associated with a particular web address (such as a URL).

As it will be further described hereinabove, each of the plurality of servers 140-160 may store content required to operate network resources in databases 146, 156, 166, each associated with one or more of the plurality of servers 140-160. The content stored in the databases 146-166 may take, for example, but without being limitative, the form of HTML, JavaScripts, image or video documents. Broadly speaking, the content stored in the databases 146-166 may be divided into two categories, static content and dynamic content.

In some embodiments, the static content may be intended to be downloaded after a first connection of the electronic device 102 to one of the servers 140-160. The static content may then be stored in a local cache 103 of the electronic device 102 so as to be later reused by the electronic device 102 without having to be downloaded again from one of the servers 140-160. Conversely, dynamic content may also be downloaded from the servers 140-160 but are not, by design, intended to be stored in the local cache 103. To the contrary, the dynamic content is to be downloaded again from the servers 140-160 every time the electronic device 102 needs to access such content.

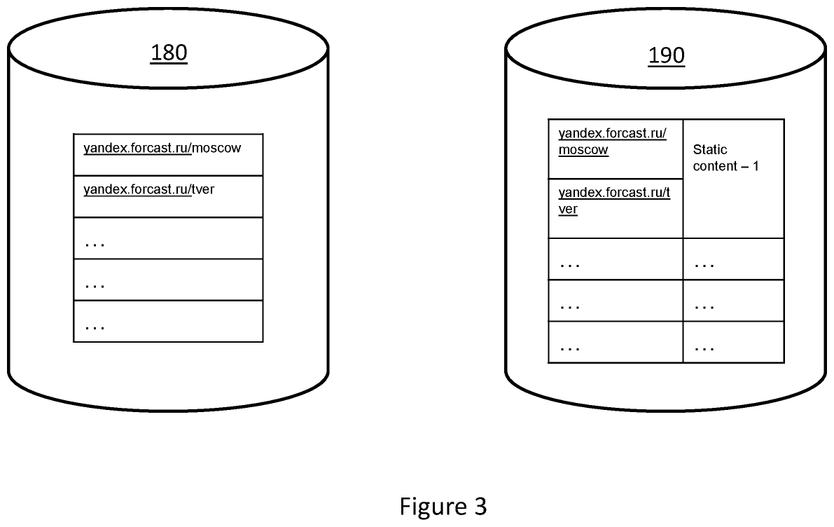

Referring now concurrently to FIGS. 1 and 3, examples of a data structure stored in the local cache 104 are shown and will be further described. In some embodiments, the data structure may take the form of two databases 180, 190 managed by the web application 113. As the person skilled in the art may appreciate, the term “database” may be broadly defined as a collection or register of structured or unstructured data. In the illustrated embodiments, the database 180 may also be referred as a “scope” or a “manifest” to convey a concept of reach associated with the web application 113 which operates the database 180. In some embodiments, the database 180 may take the form of a list of URLs which may be updated by the web application 113 and relied upon to determine a triggering event which leads the web application to be “activated” and to interact with a given web resource. As a non-limiting example, the triggering of the launch of the web application 113 may be a user of the electronic device 102 browsing from a SERP to a web resource (e.g., clicking on a link associated with the web resource) which, de facto, becomes the web resource selected by the user. The web application 113 may determine that the selected web resource is listed in the database 180 and, as a result, determines that the selection of the web resource by the user is a triggering event for which the web application 113 is to be launched. It should be understood that the monitoring of the triggering event may be executed by the web application 113 itself or, alternatively by a software component operating outside of the web application (e.g., operated by an operating system of the electronic device 102). By “launching”, it should be understood that the web application 113 may be operating in the background (i.e., not visible to the user of the electronic device 102) and be brought into an “active” mode in response to the triggering event. In alternative embodiments, the web application 113 may not be operated and is actually started upon detection of the triggering event.

While the embodiment illustrated at FIG. 3 shows the database 180 populated with a list of Unified Resource Locators (URLs), it should be understood that other types of web resource identifiers may be used such as, but without being limited to, Internet Protocol (IP) addresses or may also be even predefined by associating an identifier with a web resource. In some embodiments, such association is based on TF/IDF parameters or predefined n-grams. In addition, the triggering event may be in response to actions other than the selection of a web resource from a SERP, for example, in response to the user entering an URL in the browser application 108. Other events may be an automatic launch of the web application 113 orchestrated by the operating system of the electronic device 102 or in response to an action posed by the user. In yet other embodiments, the association between the identifier and the web resource is based on presence of symbols sequence in a string or regular phrases. In other embodiments, the association is based on URL-filters coded in Javascript such as a function “hostContains” which matches if the host name of the URL contains a specified string. Other functions further described in the Appendix may also be used, these functions also being available at https://developer.chrome.com/docs/extensions/reference/events/#type-UrlFilter, the content of which is hereby included by reference.

In some embodiments, the launch of the web application 113 in response to the triggering event also comprises accessing the database 190 in which static content associated with web resources listed in the database 180 is stored. As an example, in response to the user clicking on a given URL, the web application 113 is launched as it has determined that the URL was within its “scope”. As the web resource is listed in the database 180, the web application 113 directly accesses the database 190 to pull out content instead of directly reaching out to the web resource. In other words, content defined as static content is directly accessed from the local cache 104 instead of being downloaded from the web resource via the network. As a result, the web application 113, upon determining that static content associated with the web resource is already stored in the local cache, pulls it from the local cache thereby avoiding any latency of delay associated with downloading such content from a remote server hosting the web resource.

The scope (e.g., a list of URLs) may be extensive. As a result, storing dedicated static content for each entry of the scope may provide to be cumbersome and demanding in terms of memory space and/or processing resources. The present technology addresses this challenge since multiple entries of the scope may share similar or common prefix. For example, a first URL “yandex.forcast.ru/moscow” and a second URL “yandex.forcast.ru/tver” have a same prefix “yandex.forcast.ru”. The content of webpages associated with the web resources hosting the first and second URLs may be divided into static content and dynamic content. As previously explained, static content may comprise content that is common to multiple web resources. In this example, because the first and second URLs share the same prefix, the static content is defined as being the same for both the first and second URLs. As a result, the static content may be said to be the same for a plurality of web resources (e.g. templates web pages in which weather forecasts are presented) while dynamic content may be specific to a given web resource. In the above example, the dynamic content may comprise the actual weather information (e.g., temperatures, humidity level, etc.) which is specific to a given place and its associated URL. The triggering of the download of the dynamic content may be based on JavaScript instructions read from the local cache 104 or accessed from the web resource.

As can be seen from FIG. 3, the database 190 stored in the local cache 104 associates the first and second URLs with a same static content “static content- 1”. As a result, a first resource associated with the first URL and a second resource associated with the second URL share similar static content. In some embodiments, the static content may comprise static components, for example, but without being limitative, web page templates, images, etc. The static content may be said to be native cache, which may, for example, be installed by the browser application 108 and/or the web application 113. The native cache may store multiple templates for multiple pages. In some embodiments, the content of the database 190 may be populated based on a set of rules forming a manifest. The manifest may define which template may be associated with a different web pages. In some embodiments, as the static content is shared between multiple web resources, the static content is said to be shared static content and/or is said to comprise shared static components. In other words, multiple web resources share portions of records stored in the local cache 104 for shared static components.

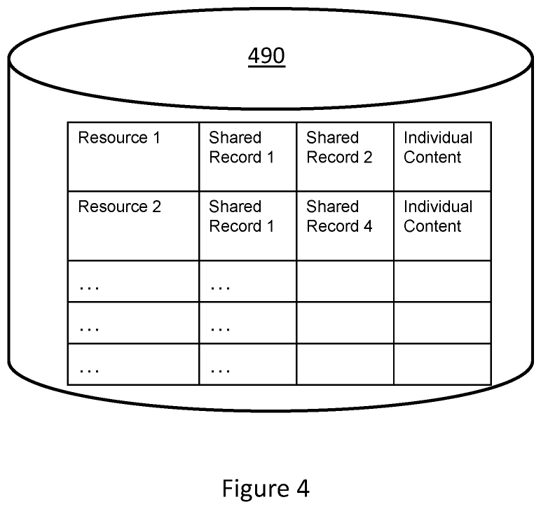

Referring now to FIG. 4, an alternative example of a data structure stored in the local cache 104 and referred to as the database 490 is shown. As the person skilled in the art of the present technology may appreciate, portions of records (e.g., “shared record 1”, “shared record 2”, “shared record 4”) are associated with multiple resources (e.g., “resource 1” and “resource 2”). In this example, the “shared record 1” is associated with both “resource 1” and “resource 2”. In other words, the “shared record 1” represents redundant static portion of data that is both relevant to “resource 1” and “resource 2”. As a result of this association, the static portion of data does not need to be stored twice in the local cache 104 (i.e., does not need to be stored a first time in relation to “resource 1” and a second time in relation to “resource 2”). The content of the database 490 may be defined prior to the launch of the web application 113. For example, a web content designer may create, for resources having common prefix (or other types of association between resources, as previously mentioned), a same static content comprising a plurality of shared portions of records (e.g., a same web page template, a same background image, profile pages in social media or news pages, etc.).

During operation, the web application 113 may therefore query the local cache 104 to pull out static content, the static content being associated with multiple resources therefore allows to reduce a size of the local cache 104 as it does not store content that is redundant amongst multiple resources. Besides, the web application 113 may also determine that dynamic content needs to be downloaded directly from the web resource. In some embodiments, this determination may be made after having established that the content is not accessible in the local cache 104 and therefore needs to be downloaded. In some other embodiments, the database 490 comprises an indication that the dynamic content has to be downloaded from the associated resource. Also, the database 490 may also comprise static content that is specific to a given resource (i.e., not shared amongst a plurality of resources).

In some embodiments, once the web application 113 has accessed both the static content and the dynamic content, it may generate the content to be displayed on a display of the electronic device 102, for example by combining the static content and the dynamic content to form the content (e.g., a web page presenting forecast for a given location, a launching page of a social network) to be displayed to the user.

Referring back to the example of the weather forecast, a triggering event may be the user clicking on a link presented by the SERP and directing to the web resource “yandex.forcast.ru/moscow”. The triggering event may be based on the determination that the web resource is within the scope of the web application 113. In response to the triggering event, the web application 113 accesses the local cache 104 and pulls out the static data defining share portions of records, i.e., portions of records that are shared by the web resource “yandex.forcast.ru/moscow” and at least another web resource (e.g., “yandex.forcast.ru/tver”). Once the static data is retrieved, the web application 113 also reaches out to the web resource to obtain the dynamic data that is specific to the selected web resource. The web application 113 then processes both the static and the dynamic components for display to the user of the electronic device 102.

As a non-limiting example, a sample of a manifest defining shared portions of records to be accessed from a local cache (e.g., also referred to as a “white list”) and dynamic content to be downloaded from a web resource (e.g., also referred to as a “black list”) is provided below. As a person skilled in the art of the present technology may appreciate, the manifest may be embodied as a JSON-based file format that provides developers with a centralized place to put metadata associated with a web application. This metadata includes, but is not limited to, the web application's name, links to icons, as well as the preferred URL to open when a user launches the web application. The manifest may also allow developers to declare a default screen orientation for their web application, as well as providing the ability to set the display mode for the application (e.g., in full screen). Additionally, the manifest may allow a developer to “scope” a web application to a URL. This restricts the URLs to which the manifest is applied and provides a means to “deep link” into a web application from other applications. Further, in accordance with some embodiments, the scope may be defined as a navigation scope of a manifest comprising scope members of a processed manifest. The navigation scope may restrict the set of URLs to which an application context may be navigated while the manifest is applied. Further details as to how a scope may be implemented are available at https://www.w3.org/TR/appmanifest/#dfn-navigation-scope, the content of which is hereby incorporated by reference.

In the example above, this portion provides a “black list”:

```
″url″: ″redirect_to_network″,
  ″filters″: [
    {
  ″pathEquals″: ″/pogoda/map″
```

In other words, the request to sub-directory/pogoda/map will not be subject to URL matching and will be searches as is. In this example, the manifest is configured so that the request sub-directory/pogoda/map is defined as dynamic content and therefore has to be retrieved from the web resource, and not from the local cache 104.

On the other hand, in this example:

```
″url″: ″/pogoda/turboapp″,
″filters″: [
  {
    ″pathEquals″: ″/pogoda″
```

The request to the sub-directory/pogoda, will be replaced with URL /pogoda/turboapp, which will search the stored template for static content in the local cache 104. It is noted that the stored template for static content can be stored in one type of cache, which is separate from HTML cache. In other words, in some embodiments, the local cache 104 is a distinct cache from the HTML cache associated with the browser application 108. By the same token, the HTML cache associated with the browser application 108 may store actual web pages recently visited. So, depending on the timing of the request, for a given user request, static content may be retrieved from the local cache 104, while dynamic content may be retrieved from the HTML cache (for example, if the page has been recently visited and stored in the HTML cache). In this manner, the requested page can be assembled without the need to go to the server associated with the web resource altogether.

In other examples, where the requested page has not been recently visited. The static content can be retrieved from the local cache 104, and the dynamic content can be retrieved form the server associated with the web resource.

In some embodiments, the searching for the static and/or dynamic content is executed in response to the URL matching portion of the manifest and is not executed if the requested URL is in the black list.

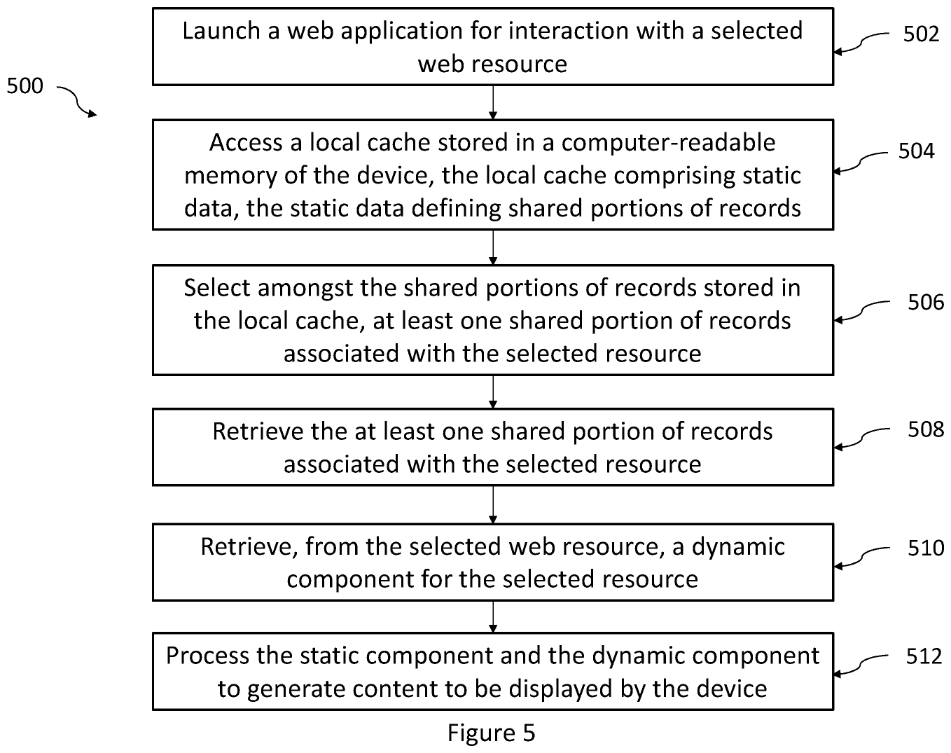

Given the architecture and examples provided hereinabove, it is possible to execute a computer-implemented method of operating a web application, in particular a PWA such as the web application 113 described hereinabove. With reference to FIG. 5, there is depicted a flow chart of a method 500, the method 500 being executable in accordance with non-limiting embodiments of the present technology. The method 500 can be executed by the electronic device 102.

Step 502—launching a web application for interaction with a selected web resource.

The method 500 starts at step 502, where the electronic device 102 launches the web application 113 for interaction with a selected web resource. In some embodiments, the launch is in response to a triggering event. In some embodiments, the triggering event is determined based on a scope associated with the web application, the scope comprising resource identifiers identifying web resources. In some embodiments, the resource identifiers are Uniform Resource Locators (URLs) associated with the web resources. In some embodiments, the triggering event is determined by a comparison of a first URL associated with the selected web resource with URLs of the scope associated with the web application. In some embodiment, the triggering event is an action of navigating from a SEarch Results Page (SERP) to the selected resource.

Step 504: access a local cache stored in a computer-readable memory of the device, the local cache comprising static data, the static data defining shared portions of records.

At step 504, the electronic device 102 accesses a local cache 104 stored in a computer-readable memory of the electronic device 102. In some embodiments, the local cache 104 comprises static data, the static data defining shared portions of records. Each of the shared portions of records is associated with at least two of the web resources. In some embodiments, each of the shared portions of records defines static content common to the corresponding at least two of the web resources. In some embodiments, the association of the shared portions of records with the at least two of the web resources is determined based on an association of a first one of the resource identifiers associated with a first one of the at least two web resources and a second one of the resource identifiers associated with a second one of the at least two web resources. In some embodiments, the association is based on the first one of the resource identifiers and the second one of the resource identifiers having a common prefix. In some embodiments, the association is predefined based on TF/IDF parameters. In yet some other embodiments, the association is predefined based on predefined n-grams. In some embodiments, the static content comprises at least one of a profile page of a social media, a new page or a template page. In some embodiments, the static data stored in the local cache further defines static content unique to the selected resource.

In some embodiments, the at least one shared portion of records associated with the selected resource comprises a first shared portion of records associated with the selected resource and a second shared portion of records associated with the selected resource.

Step 506: selecting amongst the shared portions of records stored in the local cache, at least one shared portion of records associated with the selected resource.

At step 506, the electronic device 102 selects amongst the shared portions of records stored in the local cache, at least one shared portion of records associated with the selected resource.

Step 508: retrieving the at least one shared portion of records associated with the selected resource.

At step 508, the electronic device 102 retrieves the at least one shared portion of records associated with the selected resource, the retrieved shared portions defining a static component for the selected resource.

Step 510: retrieving, from the selected web resource, a dynamic component for the selected resource.

At step 510, the electronic device 102 retrieves from the selected web resource, a dynamic component for the selected resource. In some embodiments, step 510 comprises executing a Java script routine downloading the dynamic component from a server associated with the selected web resource.

Step 512: processing, by the web application, the static component and the dynamic component to generate content to be displayed by the device.

At step 512, the electronic device 102 processes the static component and the dynamic component to generate content to be displayed by the device. In some embodiments, the method 500 further comprises opening a web page comprising the static component and the dynamic component.

Modifications and improvements to the above-described implementations of the present technology may become apparent to those skilled in the art. The foregoing description is indented to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

What is claimed is:

1. A method of operating a web application on a device, the method comprising:
in response to a triggering event, launching the web application for interaction with a selected web resource, the triggering event being determined based on a scope associated with the web application, the scope comprising resource identifiers identifying web resources;
accessing, by the web application, a local cache stored in a computer-readable memory of the device, the local cache comprising static data, the static data defining shared portions of records, each of the shared portions of records being associated with at least two of the web resources, each of the shared portions of records defining static content common to the corresponding at least two of the web resources;
selecting, by the web application, amongst the shared portions of records stored in the local cache, at least one shared portion of records associated with the selected resource;
retrieving, by the web application, the at least one shared portion of records associated with the selected resource, the retrieved shared portions defining a static component for the selected resource;
retrieving, by the web application, from the selected web resource, a dynamic component for the selected resource; and
processing, by the web application, the static component and the dynamic component to generate content to be displayed by the device.

2. The method of claim 1, wherein the resource identifiers are Uniform Resource Locators (URLs) associated with the web resources.

3. The method of claim 1, wherein the triggering event is determined by a comparison of a first URL associated with the selected web resource with URLs of the scope associated with the web application.

4. The method of claim 1, wherein the triggering event is an action of navigating from a SEarch Results Page (SERP) to the selected resource.

5. The method of claim 1, wherein the association of the shared portions of records with the at least two of the web resources is determined based on an association of a first one of the resource identifiers associated with a first one of the at least two web resources and a second one of the resource identifiers associated with a second one of the at least two web resources.

6. The method of claim 1, wherein the association is based on the first one of the resource identifiers and the second one of the resource identifiers having a common prefix.

7. The method of claim 1, wherein the association is predefined based on TF/IDF parameters.

8. The method of claim 1, wherein the association is predefined based on predefined n-grams.

9. The method of claim 1, wherein launching the web application for interaction comprises opening a web page comprising the static component and the dynamic component.

10. The method of claim 1, wherein the static data stored in the local cache further defines static content unique to the selected resource.

11. The method of claim 1, wherein retrieving, by the web application, from the selected web resource, the dynamic component comprises executing a Java script routine downloading the dynamic component from a server associated with the selected web resource.

12. The method of claim 1, wherein the static content comprises at least one of a profile page of a social media, a new page or a template page.

13. The method of claim 1, wherein the at least one shared portion of records associated with the selected resource comprises a first shared portion of records associated with the selected resource and a second shared portion of records associated with the selected resource.

14. A system for operating a web application, the system comprising a computer- readable memory storing instructions which, upon being executed by a processor of the system, causes:
in response to a triggering event, launching the web application for interaction with a selected web resource, the triggering event being determined based on a scope associated with the web application, the scope comprising resource identifiers identifying web resources;
accessing, by the web application, a local cache stored in a computer-readable memory of the device, the local cache comprising static data, the static data defining shared portions of records, each of the shared portions of records being associated with at least two of the web resources, each of the shared portions of records defining static content common to the corresponding at least two of the web resources;
selecting, by the web application, amongst the shared portions of records stored in the local cache, at least one shared portion of records associated with the selected resource;
retrieving, by the web application, the at least one shared portion of records associated with the selected resource, the retrieved shared portions defining a static component for the selected resource;
retrieving, by the web application, from the selected web resource, a dynamic component for the selected resource; and
processing, by the web application, the static component and the dynamic component to generate content to be displayed by the device.

15. The system of claim 14, wherein the triggering event is determined by a comparison of a first URL associated with the selected web resource with URLs of the scope associated with the web application.

16. The system of claim 14, wherein the triggering event is an action of navigating from a SEarch Results Page (SERP) to the selected resource.

17. The system of claim 14, wherein the association of the shared portions of records with the at least two of the web resources is determined based on an association of a first one of the resource identifiers associated with a first one of the at least two web resources and a second one of the resource identifiers associated with a second one of the at least two web resources.

18. The system of claim 14, wherein the association is based on the first one of the resource identifiers and the second one of the resource identifiers having a common prefix.

19. The system of claim 14, wherein the at least one shared portion of records associated with the selected resource comprises a first shared portion of records associated with the selected resource and a second shared portion of records associated with the selected resource.

20. The system of claim 14, wherein the static data stored in the local cache further defines static content unique to the selected resource.
